(19) United States
(12) Patent Application Publication
(10) Pub. No.: US 2013/0320912 A1
(43) Pub. Date: Dec. 5, 2013

(54) SYSTEM FOR CHARGING AN ENERGY STORE, AND METHOD FOR OPERATING THE CHARGING SYSTEM

(71) Applicants: Peter Feuerstack, Ludwigsburg (DE); Erik Weissenborn, Stuttgart (DE); Martin Kessler, Schwaebisch Gmuend (DE)

(72) Inventors: Peter Feuerstack, Ludwigsburg (DE); Erik Weissenborn, Stuttgart (DE); Martin Kessler, Schwaebisch Gmuend (DE)

(73) Assignee: ROBERT BOSCH GMBH, Stuttgart (DE)

(21) Appl. No.: 13/984,291

(22) PCT Filed: Dec. 29, 2011
(86) PCT No.: PCT/EP2011/074221

§ 371 Date: Aug. 8, 2013

(30) Foreign Application Priority Data
Feb. 9, 2011 (DE) 10 2011 003 863.9

(51) Int. Cl. H02J 7/35; H02J 7/02

(52) U.S. Cl. CPC H02J 7/35; H02J 7/025
USPC 320/101

(57) ABSTRACT

The invention relates to a system for charging at least one energy storing cell (5) in a controllable energy store (2) that is used to control and supply electric energy to an n-phase electric machine (1), wherein n≧1. The controllable energy store (2) has n parallel energy supply branches (3-1, 3-2, 3-3), each of which has at least two serially connected energy storing modules (4), each said energy storing module comprising at least one electric energy storing cell (5) with a corresponding controllable coupling unit (6). The energy supply branches (3-1, 3-2, 3-3) can be connected to a reference bus (T-), and each energy supply branch can be connected to a phase (U, V, W) of the electric machine (1). The coupling units (6) bridge the respective corresponding energy storing cells (5) or connect same into the respective energy supply branch (3-1, 3-2; 3-3) dependent on control signals. The aim of the invention is to allow at least one energy storing cell (5) to be charged. This is achieved in that at least one external energy source (10) can be connected to an energy supply branch (3-1; 3-2; 3-3) and to the reference bus (T-).

### BACKGROUND OF THE INVENTION

The invention relates to a system for charging an energy store and a method for operating the charging system according to the invention.

### TECHNICAL FIELD

It appears that electronic systems, which combine new energy storage technologies with electric drive technology, will increasingly be used in the future in stationary applications, such as, e.g., wind turbines, as well as in motor vehicles, such as hybrid and electric vehicles. In conventional applications, an electric machine, which, e.g., is embodied as an induction machine, is controlled via an electrical energy converter in the form of an inverter. A so-called D.C. link, via which an energy store, typically a battery, is connected to the D.C. side of the inverter, is characteristic of such systems. In order to be able to meet the requirements for performance and energy necessary for any given application, a plurality of battery cells is connected in series. Because the current provided from such an energy store has to flow through all of the battery cells and a battery cell can conduct only a limited current, battery cells are often additionally connected in parallel in order to increase the maximum current.

Besides having a high total voltage, the series connection of a plurality of battery cells poses the problem that the entire energy store fails if a single battery cell fails. As a result, battery current can no longer flow. Such a failure of the energy store can lead to a failure of the total system. In the case of a motor vehicle, a failure of the drive battery can lead to a breakdown of the vehicle. In other applications, such as, e.g., the rotor blade adjustment of wind turbines, situations which endanger safety can even arise when outside conditions are unfavorable, such as, e.g., when strong winds prevail. It is therefore always the goal to achieve a high degree of reliability of the energy store, wherein “reliability” refers to the capability of a system to operate in an error-free manner for a predetermined amount of time.

In the earlier German patent applications DE 10 2010 027857 and DE 10 2010 027861, batteries comprising a plurality of battery module lines are described which can be directly connected to an electric machine. The battery module lines have a plurality of battery modules connected in series. Each battery module comprises at least one battery cell and a corresponding controllable coupling unit, which allows said module to disconnect the respective battery module line or to bridge the at least one respective corresponding battery cell or connect said at least one respective corresponding battery cell into the respective battery module line as a function of control signals. By suitably actuating the coupling units, e.g. with the aid of pulse width modulation, suitable phase signals for controlling the electric machine can also be provided so that a separate pulse width modulated inverter can be eliminated. The pulse width modulated inverter required for controlling the electric machine is thereby for all intents and purposes integrated into the battery. For the purpose of disclosure, these two earlier applications are completely incorporated into the present application.

### SUMMARY OF THE INVENTION

The invention provides a system for charging at least one energy storing cell in a controllable energy store that is used to control and supply electric energy to an n-phase electric machine, wherein n≧1. The controllable energy store has n parallel energy supply branches, each of which has at least two serially connected energy storing modules, each said energy storing module comprising at least one electric energy storing cell with a corresponding controllable coupling unit. The energy supply branches can be connected to a reference bus, and each energy supply branch can be connected to a phase of the electric machine. The coupling units bridge the respective corresponding energy storing cells or they connect said respective corresponding energy storing cells into the respective energy supply branch. At least one external energy source can be connected both to an energy supply branch and to the reference bus.

The invention further provides a method for operating a charging system according to the invention, wherein the energy storing cells in all of the energy supply branches are simultaneously charged.

The invention is based on the basic concept that in order to charge the energy storing cells, the energy supply branches are electrically connected directly to an external energy source without interconnecting an additional charging component.

Besides saving on additional charging components, the system according to the invention is characterized in that a simultaneous charging of energy storing cells in all of the energy supply branches, in particular a simultaneous charging of all of the energy storing cells of the controllable energy store, is possible in the case of charging currents which can be individually adjusted by the controllable energy store.

According to the invention, an external energy source is directly connected to the energy supply branches and thereby also to the corresponding phase of the electric machine. In so doing, a distinct external energy source does not have to be provided for each energy supply branch because the individual energy supply branches are electrically connected to each other via the phases of the electric machine and the star point of the electric machine. This allows a charging current flow through all of the energy supply branches.

In such an embodiment, the charging current flows however also via the motor inductances, which in reality are not ideal and therefore have a parasitic, resistive component that impedes the current flow. In order to get around this problem, n external energy sources can be provided which on the one hand can be connected to respectively one energy supply branch and on the other hand can be connected to the reference bus. In this case, each energy supply branch has its own energy source, which can feed a charging current directly into the respective energy supply branch without having to detour over the electric machine.

According to one embodiment of the invention, the external energy sources are embodied as current sources. As a result, said energy sources can advantageously be connected in parallel to the controllable energy store acting as the voltage source without further measures having to be taken. This occurs because the charging current through the current sources is automatically limited.

As an alternative thereto, the energy sources can also be embodied as voltage sources, the voltage values of which lie below the voltages of the energy supply branch connected in each case. In so doing, the problem however arises that the charging current is not automatically limited by the voltage sources so that said voltage sources cannot necessarily be connected in parallel to the controllable energy store acting as the voltage source. This problem is however solved by virtue of the fact that, besides the voltage sources, the energy sources comprise in each case additional serially connected charging inductances, which can be operated in combination with the coupling units as boost converters. The voltage sources, however, take on a “current source character”, and therefore additional charging components are also not required with the use of voltage sources as external energy stores.

According to one embodiment of the invention, the energy sources, which can be connected to the energy supply branches of the controllable energy store, are embodied as D.C. voltage sources or D.C. current sources. If the coupling units of the controllable energy store are, however, designed as full bridges, the energy sources can thus also be alternatively configured as symmetrical A.C. voltage sources or A.C. current sources.

In the case of coupling units in the form of full bridges, the energy sources can also be configured as asymmetrical A.C. voltage sources or A.C. current sources. In order to prevent undesirable moments during the charging process, controllable switching elements are provided in this case, via which the electric machine can be separated from the energy supply branches.

Undesirable moments can be alternatively or additionally prevented during the charging process as a result of the electric machine being mechanically blocked during the charging process, e.g., with the aid of a transmission pawl. As an alternative, the rotor position of the electric machine can also be monitored, e.g., with the aid of corresponding sensors and in the event of a detected rotor movement be switched off

Further features and advantages of embodiments of the invention ensue from the following description with reference to the attached drawings.

### BRIEF DESCRIPTION OF THE DRAWINGS

In the drawings:

FIG. 1 shows a schematic depiction of a first embodiment of a charging system according to the invention;

FIG. 2 shows a schematic depiction of a second embodiment of a charging system according to the invention in a charging phase;

FIG. 3 shows the charging system pursuant to FIG. 2 in a free-wheeling phase.

### DETAILED DESCRIPTION

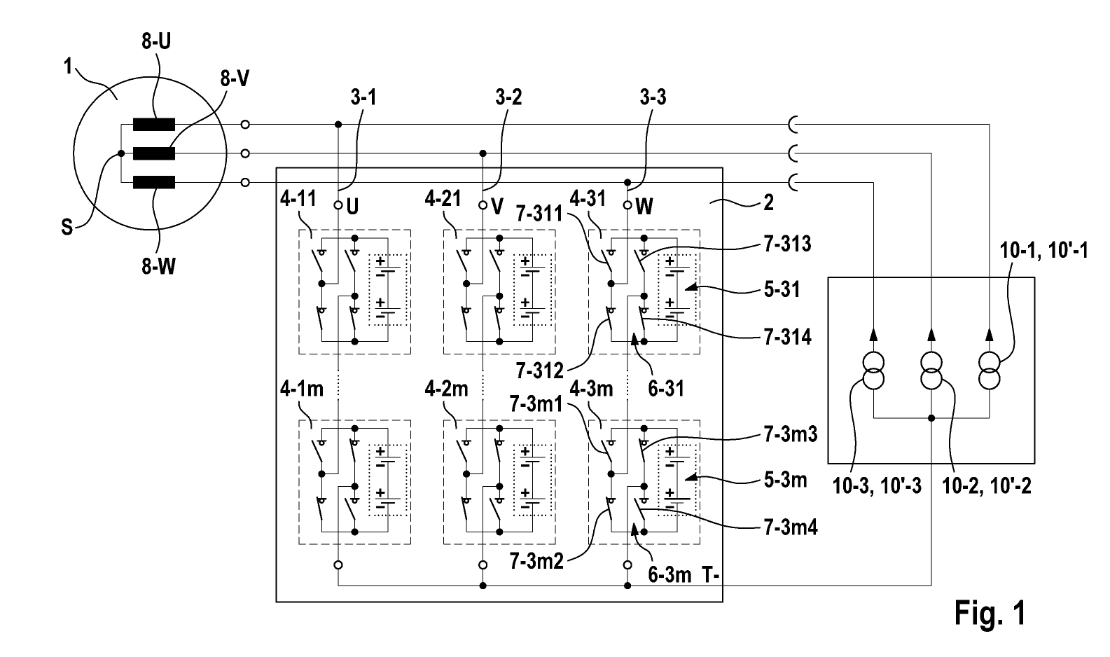

The FIGS. 1 to 3 show schematic depictions of embodiments of a charging system according to the invention. A controllable energy store 2 is connected up to a three-phase electric machine 1. The controllable energy store 2 comprises three energy supply branches 3-1, 3-2 and 3-3, which are connected on the one hand to a reference potential T- (reference bus), which carries a low potential in the depicted embodiments, and on the other hand respectively to individual phases U, V, W of the electric machine 1. Each of the energy supply branches 3-1, 3-2 and 3-3 have serially connected energy storing modules 4-11 to 4-1m or 4-21 to 4-2m or 4-31 to 4-3m, wherein m≧2. The energy storing modules 4 comprise in turn respectively a plurality of serially connected, electric energy storing cells, which for reasons of clarity are provided with reference numerals 5-31 to 5-3m only in the energy supply branch 3-3 connected to the phase W of the electric machine 1. The energy storing modules 4 further comprise respectively one coupling unit, which is associated with the energy storing cells 5 of the respective energy storing module 4. For reasons of clarity, the coupling units are also provided with reference numerals 5-31 to 5-3m only in the energy supply branch 3-3. In the depicted embodiment variants, the coupling units 6 are formed in each case by four controllable switching elements 7-311, 7-312, 7-313 and 7-314 to 7-3m1, 7-3m2, 7-3m3 and 7-3m4, which are interconnected in the form of a full bridge. The switching elements can thereby be embodied as power semiconductor switches, e.g., in the form of IGBTs (Insulted Gate Bipolar Transistors) or as MOSFETs (Metal Oxide Semiconductor Field-Effect Transistors).

The coupling units 6 allow the respective energy supply branch 3 to be interrupted by opening all of the switching elements 7 of a coupling unit 6. The energy storing cells 5 can alternatively either be bridged by closing respectively two of the switching units 7 of a coupling unit 6, e.g. closing the switches 7-312 and 7-314 or be switched into the respective energy supply branch 3, e.g. closing the switch 7-312 and 7-313.

The total output voltages of the energy supply branches 3-1 to 3-3 are determined by the respective switching state of the controllable switching elements 7 of the coupling units 6 and can be adjusted in a stepped manner. The step range results as a function of the voltage of the individual energy storing modules 4. If the use of the preferred embodiment of uniformly designed energy storing modules 4 can be assumed, a maximum possible total output voltage thus results from the voltage of a single energy storing module 4 times the number m of the serially connected energy storing modules 4 per energy supply branch 3.

The coupling units 6 thereby allow the phases U, V, W of the electric machine 1 to be switched in opposition to a high reference potential or a low reference potential and can in this respect fulfill the function of a known inverter. During suitable actuation of the coupling units 6, power and operating mode of the electric machine 1 can thus be controlled by means of the controllable energy store 2. The controllable energy store 2 therefore fulfills in this respect a double function because said energy store on the one hand supplies the electric machine 1 with energy and on the other hand also controls said electric machine 1.

The electric machine 1 has stator windings 8-U, 8-V and 8-W, which are connected in a known manner to one another in a star connection.

The electric machine 1 is embodied as a three-phase machine in the exemplary embodiments depicted, can, however, have less or more than three phases. The number of energy supply branches 3 in the controllable energy store 2 is, of course, also determined by the number of phases of the electric machine.

In the exemplary embodiments depicted, each energy storing module 4 has respectively a plurality of serially connected energy storing cells 5. The energy storing modules 4 can, however, alternatively also have respectively only one single energy storing cell or also energy story cells connected in parallel.

In the exemplary embodiments depicted, the coupling units 6 are formed in each case by four controllable switching elements 7 in the form of a full bridge, which also makes the option available for a voltage reversal at the output of the energy storing module. The coupling units 6 can, however, also be implemented using more or fewer controllable switching elements so long as the necessary functions (bridging the energy supply cells and connecting said energy supply cells into the energy supply branch) can be implemented. In particular, the coupling units can also be embodied in the form of half bridges. Such embodiments ensue by way of example from the earlier German patent applications DE 10 2010 027857 and DE 10 2010 027861.

In order to make the charging of energy storing cells 5 of one or a plurality of energy storing modules 4 possible, three external energy sources 10-1 or, respectively, 10-2 or, respectively, 10-3, which are designed as current sources 10′-1, 10′-2 and 10′-3, are provided, said energy sources being connected on the one hand to respectively one energy supply branch 3-1 or 3-2 or 3-3 and on the other hand to the reference bus T-. The current sources 10′ can thereby be embodied as D.C. sources or also as A.C. sources as in the depicted embodiment of the coupling units 6 as full bridges and provide in each case a charging current suitable for charging the energy storing cells 5 in the corresponding energy supply branch 3. Because the individual energy supply branches 3-1 to 3-3 are connected to one another via the star point S of the electric machine 1, it is also conceivable as an alternative to the depicted embodiment variant not to provide each of the energy supply branches 3 with its own current source 10′ but to connect only a portion of the energy supply branches 3 to a current source 10′.

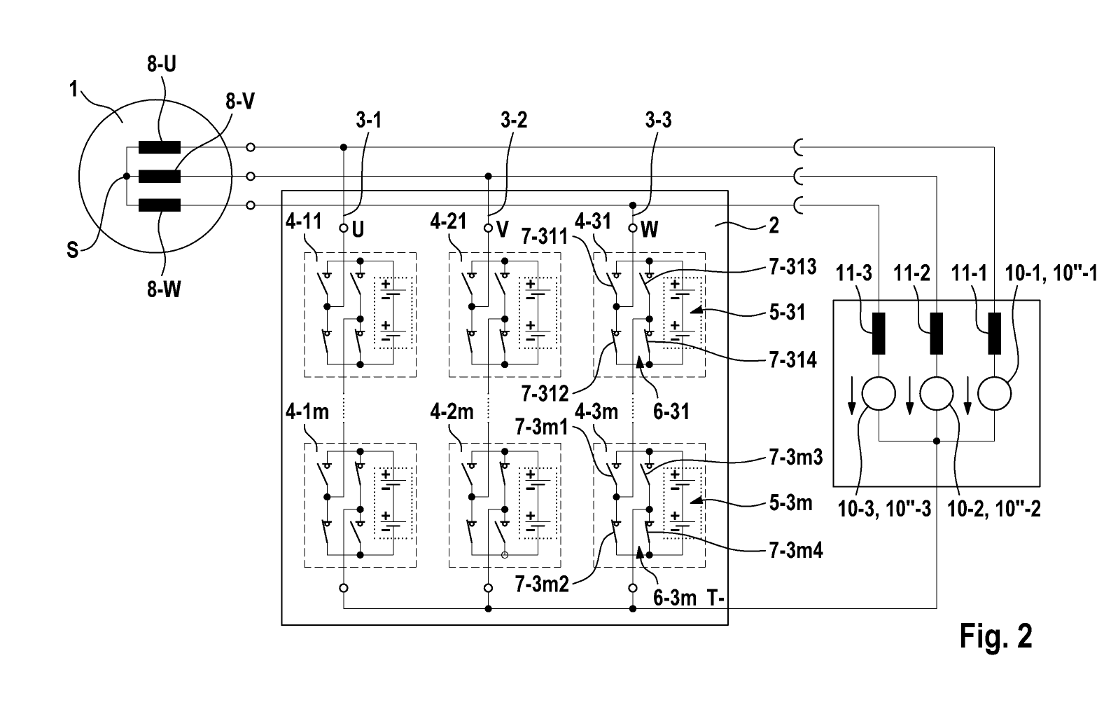

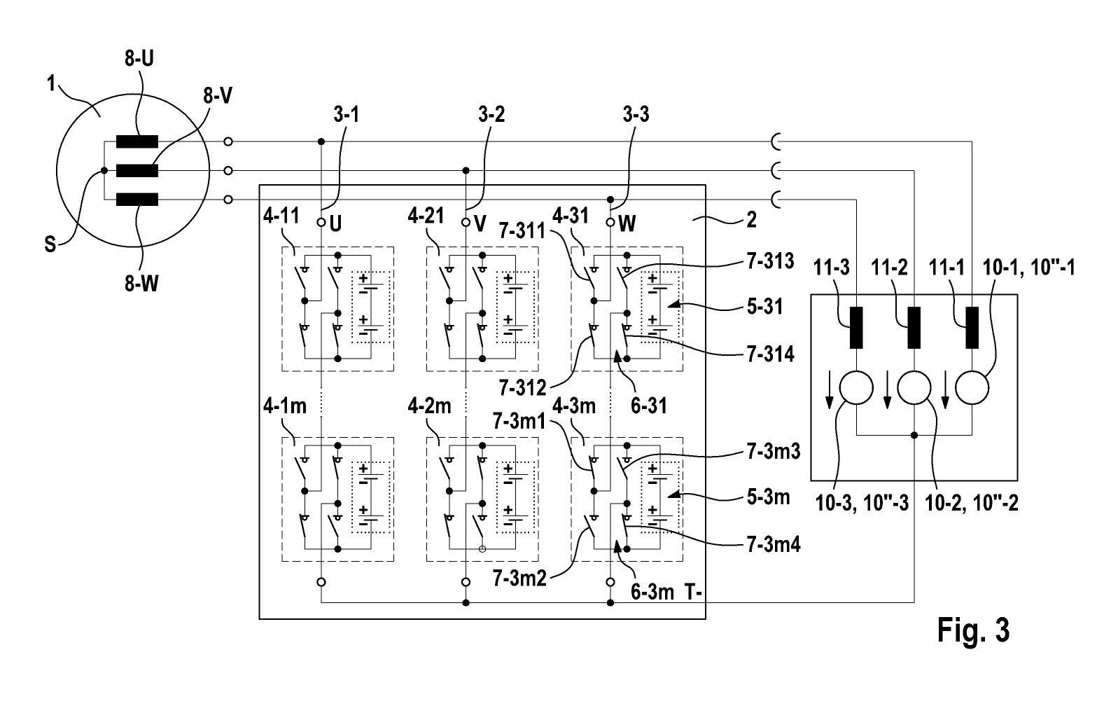

FIGS. 2 and 3 show a second embodiment of the invention. This differs from the third embodiment by the fact that the external energy sources 10-1, 10-2 and 10-3 are not designed as current sources but as voltage sources 10″-1, 10″-2 and 10″-3, the voltage values of which lie below the voltages of the energy supply branches 3-1 to 3-3. In addition, the energy sources 10-1, 10-2 and 10-3 comprise respectively a charging inductance 11-1 or 11-2 or 11-3 serially connected to the voltage source 10″-1 or 10″-2 or 10″-3. In this context, the voltage sources 10″ can be implemented as D.C. voltage sources or in the embodiment of the coupling units 6 as full bridges also as A.C. voltage sources. In order also in the case of voltage source 10″ to provide a charging current suitable for charging the energy storing cells 5, the charging process has to thereby take place in two phases. This charging process is described exemplarily below for the charging process of the energy storing cells 5 of an individual energy storing module 4, namely the energy storing cells 5-3m of the energy storing module 4-3m in the energy supply branch 3-3, with the aid of a voltage source 10″ embodied as a D.C. voltage source. The coupling units 6 are thereby operated in combination with the additional charging inductances 11 as boost converters.

During the charging phase, which is depicted in FIG. 2, the coupling units 6-31 to 6-3m of the energy storing modules 4-31 to 4-3m, which lie in the energy supply branch 3-3, in which the energy storing cells 5-31 to be charged also lie, are controlled by a non-depicted control unit, such that the respectively corresponding energy storing cells 5-31 to 5-3m are bridged. This is concretely achieved by virtue of the fact that the switching elements 7-312 and 7-314 to 7-3m2 and 7-3m4 are closed, whereas the switching elements 7-311 and 7-313 to 7-3m1 and 7-3m3 are open. All remaining coupling units 6, i.e. all coupling units 6 in the energy storing modules 4 of the other two energy supply branches 3-1 and 3-2 are controlled such that the respective energy supply branch 3-1 or, respectively, 3-2 is interrupted. This is achieved concretely as a result of all switching elements 7 of the coupling units being open in each case.

Such an activation of the coupling units 6 causes a current flow through the charging inductance 11-3; thus enabling electrical energy to be stored in the charging inductance 11-3 during the charging phase.

In a free-wheeling phase subsequent to the charging phase, which free-wheeling phase is depicted in FIG. 3, the coupling unit 6-3m, which is associated with the energy storing cells 5-3m, is controlled such that the corresponding energy storing cells 5-3m are connected into the energy supply branch 3-3. This is concretely achieved as a result of the switching elements 7-3m2 and 7-3m3 being open and the switching elements 7-3m1 and 7-3m4 being closed. All remaining coupling units 6-31 to 6-3(m1), which lie in the energy supply branch 3-3 of the energy storing cells 5-3m to be charged but themselves are not associated with any energy storing cells 5 to be charged, are controlled such that the respectively corresponding energy storing cells 5-31 to 5-3(m-1) are bridged (closing of the switching elements 7-312 and 7-314 to 7-3(m-1)2 to 7-3(m-1)4 and opening of the switching elements 7-311 and 7-313 to 7-3(m-1)1 to 7-3(m-1)3). The coupling units 6-11 to 6-1m and 6-21 to 6-2m in the remaining energy supply branches 3-1 and 3-2 are furthermore controlled such that the respective energy supply branches 3-1 and 3-2 are interrupted.

Such a control of the coupling units 6 brings about an electrical connection between the charging inductance 11-3 and the energy storing cells 5-3m to be charged. The charging inductance 11-3 thereby drives the current further on and thus charges the energy storing cells 5-3m.

In the manner described above, practically all energy storing cells 5 in all of the energy supply branches 3 of the controllable energy store 2 can be charged. Using the inventive system, it is, however, also possible by means of a corresponding actuation of the coupling units 6 to charge a plurality of energy storing cells 5 in a plurality of energy supply branches 3 or even to simultaneously charge all of the energy supply cells 5. A distribution of a current, which is fed by the energy source 10, to the individual energy supply branches 3 can be adjusted via the voltages of the energy supply branches 3. The voltages of the energy supply branches 3 are in turn determined by the number of energy storing cells 5 connected into the respective energy supply branch 3.

Also in the case of the embodiment explained with the aid of FIGS. 2 and 3, it is conceivable as an alternative to the depicted variant, not to provide each of the energy supply branches with its own voltage source 10″, but to connect only a portion of the energy supply branches 3 to a voltage source 10′. The invention also thereby takes advantage of the fact that the individual energy supply branches 3-1 to 3-3 are already connected to one another via the star point S of the electric machine 1.

If, when directly coupling energy sources 10 to the energy supply branches 3 of the controllable energy store 2, asymmetrical A.C. voltage sources, such as, e.g., the public network, are used, undesirable moments can be produced in the electric machine. For that reason, controllable switching elements that are not depicted in the present application can be provided, which allow the electric machine 1 to be separated from the energy supply branches during the charging process.

Undesirable moments can also be prevented during the charging process by virtue of the fact that the electric machine 1 is mechanically blocked during the charging process, e.g. with the aid of a transmission pawl. The rotor position of the electric machine 1 can also alternatively be monitored, e.g., with the aid of appropriate sensors, said electric machine being switched off in the event of a rotor movement being detected.

1. A system for charging at least one energy storing cell in a controllable energy store that is used to control and supply electric energy to an n-phase electric machine, wherein n≧1,
the controllable energy store having n parallel energy supply branches, which
have respectively at least two serially connected energy storing modules, each said energy storing module comprising at least one electric energy storing cell with a corresponding controllable coupling unit,
can be connected on the one hand to a reference bus and
can be connected on the other hand to a phase of the electric machine,
the coupling units bridging the respective corresponding energy storing cells or connecting said respective corresponding energy storing cells into the respective energy supply branch dependent on control signals,
at least one external energy source being able to be connected on the one hand to an energy supply branch and on the other hand to the reference bus.

2. The system according to claim 1, wherein n external energy sources are provided, which can be connected on the one hand to respectively one energy supply branch and on the other hand to the reference bus.

3. The system according to claim 1, wherein the energy sources are embodied as current sources.

4. The system according to claim 1, wherein the external energy sources comprise voltage sources having additionally in each case serially connected, additional charging inductances, wherein voltage values of the voltage sources lie below the voltages of the energy supply branch that is connected in each case, and wherein the coupling units in combination with the additional charging inductances can be operated as a boost converter.

5. The system according to claim 1, wherein the energy sources are embodied as D.C. current sources or D.C. voltage sources.

6. They system according to claim 1, wherein the energy sources are embodied as symmetrical A.C. current sources or A.C. voltage sources and the coupling units are embodied as full bridges.

7. The system according to claim 1, wherein the energy sources are embodied as asymmetrical A.C. current sources or A.C. voltage sources and the coupling units as full bridges and wherein the electric machine can be separated from the energy supply branches by controllable switching elements.

8. A method for operating a charging system according to claim 1, the method comprising simultaneously charging energy storing cells in the energy supply branches.
